(19) United States
(12) Patent Application Publication
(10) Pub. No.: US 2015/0152328 A1
(43) Pub. Date: Jun. 4, 2015

(54) PHOTOACTIVATED ETCHING PASTE AND ITS USE

(71) Applicant: Merck Patent GmbH, Darmstadt (DE)

(72) Inventors: Jun Nakanowatari, Sagamihara (JP); Tomohisa Goto, Sagamihara (JP)

(73) Assignee: Merck patent GmbH, Darmstadt (DE)

(21) Appl. No.: 14/405,735

(22) PCT Filed: May 7, 2013
(86) PCT No.: PCT/EP2013/001354

§ 371 Date: Dec. 4, 2014

(30) Foreign Application Priority Data
Jun. 4, 2012 (EP) 12004239.5

(51) Int. Cl. C09K 13/06; H01B 13/00

(52) U.S. Cl. CPC C09K 13/06; H01B 13/003; H01B 13/0006

(57) ABSTRACT

The improved method for the etching of transparent conductive oxide layers placed on flexible polymer substrates, hard substrates like glass or on silicon wafers comprises the use of new etching pastes, which are activated by irradiation.

The object of the present invention is an improved method for the etching of transparent conductive oxide layers placed on flexible polymer substrates or on hard substrates like glass or silicon wafers by use of new etching pastes, which are also part of the invention.

### PRIOR ART

The most frequently used patterning method for transparent conductive oxide layers (transparent conductive oxide layer) in display industry is the photo-resist etching process.

This is an established technology in display and electronics industry. Equipment and materials, such as photo-resist and etching compositions, are widely available. However this technology consumes a lot of resin, organic solvents and other chemicals.

Usually this process will emit a lot of waste water. This is why customers need an additional waste water treatment facility.

In general this process is mainly focused on the treatment of hard substrates, like glass-substrates with ITO layers, and for example silicon wafers. If the users want to apply the photo-resist etching process on polymer substrates, usually they cannot use the existing equipment, which is designed for the treatment of hard substrates.

Recently Merck has developed the new Hiper Etch™ technology, which is using a screen printing method for the pattering of transparent conductive oxide layers. This is a process, which may be carried out very simply and easily in comparison to conventional photo-resist etching processes. Even the treatment of polymer substrates is possible and may be processed without any problems. However if the screen printing method is used, there are some restrictions to the accuracy of the patterning of transparent conductive oxide layers on flexible polymer substrates.

### OBJECT

Nowadays, most of the manufacturers of displays or electronics are trying to reduce the consumption and the referring total emission of chemicals in order to prevent the environmentally pollution.

Since lately many companies tried to develop flexible devices with polymer substrates. For example, most of the manufacturers want to introduce display devices with a polymer substrate for E-paper and E-book application. One big challenge of this development is the introduction of a reasonable patterning method of transparent conductive oxide layer in mass production.

Thus, the object of the present invention is to provide an inexpensive, simple and fast etching process for the pattering of transparent conductive oxide layers on flexible polymer substrates with reduced need for chemicals and a decreased total emission of chemicals into the environment. A further object of the present invention is to provide a suitable method for patterning of transparent conductive oxide layers on flexible polymer substrates with high accuracy.

But what is also needed is a process for reproducibly patterning a wide variety of substrates with a lateral dimension of 80 μm or less, preferably less than 50 μm. The processes should be low-cost, highly reproducible and scalable. In particular, a process has to be provided by which features can be produced having at least lateral dimensions of 50 μm or less and by which features can be formed simultaneously having much larger lateral dimensions.

### DESCRIPTION OF THE INVENTION

The present invention relates to a method for the etching of transparent conductive oxide layers placed on flexible polymer substrates or on hard substrate like glass or a silicon wafer, comprising the steps of
a) applying the etching pastes comprising at least one compound, which is a photo-acid generator,
b) activating the etching composition by UV irradiating those areas, which shall be etched,
c) removing the etching paste by rinsing off with water and
d) drying the treated surface.

This method is entirely suitable for the etching of transparent conductive oxide layers, which consist of indium tin oxide (ITO), fluorine tin oxide (FTO), or aluminium tin oxide (AZO) or antimony tin oxide (ATO) by applying a thin layer of the etching composition on to the transparent conductive oxide layer the by spin coating or by screen printing, silk-screen printing, pad printing, stamp printing and ink-jet printing. When the composition either in form of a liquid mixture or of a paste is applied to the surface to be etched it is activated by irradiating the entire surface layer, by what only the surface areas covered by etching composition are etched. If the etching composition is applied to the whole surface a photo mask is positioned over the transparent conductive oxide layer, which is covered with etching paste and only those areas are activated by irradiation, which are irradiated through the pattern of the photo mask. Good etching results are achieved, if the UV irradiation lasts for 20 seconds to 2 minutes.

The present invention also relates to a new and improved etching composition, which comprises
a) at least one compound, which is a photo acid generator
b) at least one etching component selected from the group phosphoric acid (ortho-, meta- or pyro-), and its salts (NH₄)₂HPO₄ and NH₄H₂PO₄, meta-phosphorus pentoxide, phosphonic acid, n-butyl phosphoric acid, di-n-butyl phosphoric acid, oligo- and polyphosphoric acids, phosphonic acid, phosphinic acid, phenylphosphinic acid, phenylphosphonic acid,
   or selected from the group mono-, di- or triesters of the said phosphoric acids, especially monomethyl phosphate, di-n-butyl phosphate (DBP) and tri-n-butyl phosphate (TBP),
c) at least an organic solvent selected from the group acetone, polyhydric alcohols like glycerin, polyethylene glycol, propylene glycol monomethylethylacetate, [2,2-butoxy(ethoxy)]-ethyl acetate, ethers, in particular ethylene glycol monobutyl ether, triethylene glycol monomethyl ether, propylene glycol monomethyl ether, propylene carbonate, cyclopentanone, cyclohexanone, γ-butyrolactone, N-methyl-2-pyrrolidone (NMP), ethyl lactate, and methoxypropyl acetate, preferably 1-methoxy-2-propyl acetate,
d) water,
e) optionally at least one thickener,
   and
f) optionally additives.

Good etching results are achievable if the concentration of the comprising etching component is in a in the range from about 25 to 50% by weight. The properties of the composition are especially advantageous if phosphoric acid is used as etching component. Advantageously etching compositions may be simply activated by UV-irradiation if they comprise at least one of the photo-acid generators of claim 11. Photoacid generators selected from the group Triphenylsulfonium trifluoromethanesulfonate, Diphenyl-4-methylphenylsulfonium trifluoromethanesulfonate, Diphenyl-2,4,6-trimethylphenylsulfonium p-toluenesulfonate, Diphenyl[4-(phenylthio)phenyl]sulfonium hexafluorophosphate, Diphenyl[4-(phenylthio)phenyl]sulfonium hexafluoroantimonate, Diphenyl(4-phenylthiophenyl)sulfonium triflate, (4,8-Dihydroxy-1-naphthyl)dimethylsulfonium triflate, Norbornane-on(3) sulfonic acid ester proved to be especially suitable.

Experiments have shown, that the concentration of the added photo-acid generator should be in the range from about 0.01 to 5% by weight depending on the chemical nature of the chosen compound. To ensure a good solubility of all components the composition should comprise not only water but also organic solvents, especially those of claim 8, in the range of 25 to 60% by weight and water in a concentration in the range of 10 to 35% by weight but with the proviso that the amount of comprising solvent and water doesn't exceed 75% by weight.

### DETAILED DESCRIPTION OF THE INVENTION

In general, in order to achieve sub-80 μm, high-resolution patterning, high resolution patterns must not only be constructed to a matrix, but the matrix or the screen must also make conformal contact with the substrate. Since this requirement is only met elaborately, another promising solution had to be found for a uniform treatment of transparent conductive oxide layers on flexible polymer films.

Unexpectedly it was found, that the problem of the restricted accuracy of the patterning of transparent conductive oxide layers on flexible polymer substrates may be solved by a method for the etching of transparent conductive oxide layers placed on flexible polymer substrates, comprising the steps of applying etching pastes containing at least one compound, which is a photo-acid generator or a photo initiator, and of irradiating only those areas of the transparent conductive oxide layer, which shall be etched. As soon as the etching step is completed, the etching paste is rinsed off and the treated surface is dried.

Thus the new photo-activated etching pastes are especially useful for the pattering of transparent conductive oxide layers. Theses pastes include at least an etchant, one or more organic solvent(s) and at least one photo-acid generator or photo initiator. In general, the etching compositions according to the invention are acidic but their etching activities are low during storing in the dark and at low temperatures, especially at temperatures less than 25° C. If applied onto transparent conductive oxide layers the etching paste can be activated by photo energy and the etching reaction of the transparent conductive oxide layer underneath will start. Usually a heating step for the etching is not necessary because of the effect of photo energy. After the photo-activated etching process took place, just a simple washing process is required. This washing step can be processed directly following the irradiation and etching step, with the effect, that no further etching takes place. Depending on the nature of the photo-acid generator or photo initiator the etching can also be stopped just by terminating the irradiation.

If a removable photo-mask or other optical methods such as UV laser are used, very fine patterns may be etched without the need of any protective photo-resist mask. Also, there is no need for directly contacting the patterned matrix or screen with the transparent conductive oxide layer. In the simplest modification of the invention etching pastes are applied in a single process step to the entire substrate surface to be etched and the etching pattern is generated by a removable photo-mask, whereas the last one is positioned ahead of the surface. But the etching composition may also be applied selectively to a major surface of the substrate to form a pattern of applied paste. For example, the paste may be applied by a printing method, such as screen-printing.

A method with a high degree of automation and high throughput which is suitable for transfer of the etching paste to the substrate surface to be etched uses printing technology. In particular, screen printing, silk-screen printing, pad printing, stamp printing and ink-jet printing methods are printing methods, which are known to the person skilled in the art, are suitable. Manual application is likewise possible. Because it saves time in a preferred embodiment of the invention the etching paste is applied by spin coating over the entire surface area of the substrate and a removable photo-mask is used, although the paste consumption is increased.

The method may be used to produce solar cells and other semiconductor products comprising structured transparent conductive oxide layers.

This means, depending on the design of the screen, silk screen, klischee or stamp or the cartridge addressing, it is possible to apply the printable, homogeneous etching pastes, which are described in accordance with the invention, over the entire area or selectively in accordance with the etch structure mask only to the points at which etching is desired.

As described above, due to the nature of the comprising etchant, which is activated by irradiation, advantageously the etching pastes can be applied very fast over the entire surface of the substrate to be etched and then a removable photo mask is positioned over the coated surface. In the next process step the coated surface is irradiated through the openings of the photo mask and the transparent conductive oxide layers are only etched in areas, which are irradiated, with the result, that the pattern may be etched with a very high accuracy and sharpness. In addition to this, the resolution of etched structures may be improved in comparison to structures evolved simply by printed etching pastes. If the etching paste is applied selectively in accordance with the etch structure mask, there is no need for a further photo mask and the surface may be irradiated entirely in order to activate the photo initiators contained in the applied etching paste.

When the etching is complete, the printable, homogeneous etching pastes, which may or may not have non-Newtonian flow behaviour are rinsed off the etched surface using a suitable solvent or it is burnt out.

The etching duration, which is induced and conducted by irradiation, can be between a few seconds and several minutes, depending on the application and on the desired etching depth of the etch structures. In general, an etching duration of between 20 seconds and two minutes is set.

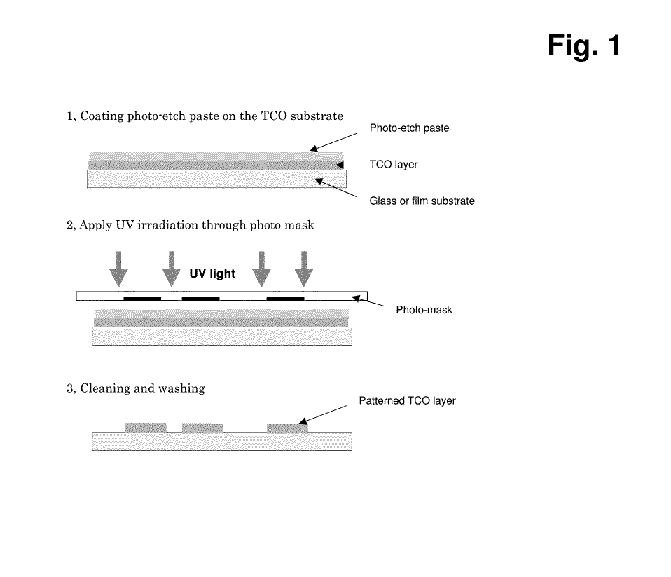

The photo activated etching process according to the present invention is schematically shown in FIG. 1.

In step 1 the photo-etching paste is applied onto the surface of the transparent conductive oxide layer, which is placed on a support layer, consisting of glass or of a flexible polymer film.

In step 2 of this process a removable photo mask is positioned on top of the coated substrate and the applied photo etching paste layer is irradiated through the openings of the photo mask or though light transmissible areas of the mask.

After irradiation for a limited period of time in step 3 of the inventive process the patterned surface is cleaned by simply washing or rinsing with water and remaining etching paste and etching products are removed. Thus in irradiated areas the transparent conductive oxide layer is removed with the result that a patterned transparent conductive oxide layer is prepared.

This means, that the process according to the present invention is very simple and easy in comparison to conventional methods for the production of patterned transparent conductive oxide layers. In Table 1 process steps of conventional etching methods are compared with those needed according to the present invention.

TABLE 1
Comparison of conventional etching methods with steps
needed for the processing of the process according to the
present invention

| | Conventional method | Method of the present invention |
|---|---|---|
| 1 | coating with a photoresist layer | coating with etching paste |
| | | comprising photo acid |
| 2 | UV irradiation | UV irradiation through movable |
| | | and reusable photo mask |
| 3 | development | washing or rinsing with water |
| 4 | etching | |
| 5 | removal of the photoresist layer | |
| 6 | washing or rinsing with water | |

This comparison shows that the present process has a double fold advantage. While conventional processes need a photoresist layer, which has to be patterned by UV irradiation and a development procedure, in the present method according to the invention only a reusable photo mask is positioned on top of the area, which has to be patterned. There is no need for chemical substances for the preparation of the patterned photoresist layer and for chemicals to remove the patterned layer after etching. In addition to this, time is saved, which is needed otherwise for the preparation of the photoresist layer and its removing.

This means, according to the present invention the etching process takes place directly when irradiation is proceeded through the reusable movable photo mask and the etched surfaces are cleaned by rinsing with water, whereas according to the conventional etching process at first a patterned photoresist layer has to be developed by UV irradiation. The layer has to be washed in order to open the pattern. Only then the surface areas, which are not covered by a photoresist layer, may be etched. Afterwards the patterned photoresist layer has to be removed by use of additional chemicals. Then the etched surfaces have to be cleaned, for example by rinsing with water, in order to remove impurities coming from the photoresist layer and the etching.

In summary, in comparison to the conventional etching process, which needs six process steps, the etching process according to the present invention may be processed in three steps, which saves a lot of chemicals and time, but which is also more environment friendly. This means, that according to the present invention no further chemicals are needed apart from the photo sensible etching paste and DI water.

In general etching compositions according to the present invention useful as photoactivatable etching pastes are composed of at least
a) an acid, which shows low activity at low temperatures, but whose activity is increased in presence of
b) a sufficient amount of an acid generator, especially preferred a photochemical acid generator, which is called a photo-acid generator,
c) an organic solvent
   and
d) water.

In addition to these compounds, the etching composition may comprise thickeners, preferably thickeners for the preparation of pastes having non-Newtonian properties, and optionally additives, such as antifoams, thixotropic agents, flow-control agents, deaerators, adhesion promoters and sensitizers.

The etching action of the proposed etching compositions is based on an acidic component which is activated through UV irradiation in the presence of a photo-acid generator. This etching component originates from the group of phosphoric acid (ortho-, meta- or pyro-), meta-phosphorus pentoxide and salts thereof, preferably ammonium salts selected from the group (NH₄)₂HPO₄ and NH₄H₂PO₄, but also phosphonic acid and alkyl- and dialkyderivates of phosphoric acid like n-butyl or di-n-butyl phosphoric acid.

For the purposes of the present invention, the term phosphoric acid is specifically taken to mean the following phosphoric acids:
ortho-phosphoric acid (H₃PO₄),
pyro-phosphoric acid (H₄PO₇),
meta-phosphoric acid [(HPO₃)ₓ],
oligo- and polyphosphoric acids,
phosphonic acid (phosphorous acid),
phosphinic acid (hypophosphorous acid),
phenylphosphinic acid and other organic phosphinic acids,
phenylphosphonic acid and other organic phosphonic acid.

Salts of phosphoric acid which can be employed are the mono-, di- and trisalts of the acids mentioned under phosphoric acids. In particular, these are taken to mean the corresponding ammonium salts. The corresponding phosphoric acids are liberated from these salts in the formulations of the etching media.

The term phosphoric acid precursors is taken to mean compounds which form phosphoric acids and/or salts thereof by chemical reaction and/or decomposition. For use in the etching media according to the invention, corresponding mono-, di- or triesters of the said phosphoric acids, such as, for example, monomethyl phosphate, di-n-butyl phosphate (DBP) and tri-n-butyl phosphate (TBP), are particularly suitable.

Phosphoric acids are per se Lewis acids which are capable of forming adducts with Lewis bases. These phosphoric acid adducts may decompose back into the starting materials.

An example of a suitable Lewis base is 1-methyl-2-pyrrolidone (NMP), which is also used in compositions according to the invention reproduced by way of example.

An effective etching component which has proven particularly effective is, in particular, phosphoric acid, more precisely in concentrations in the range from about 25 to 50% by weight. Compositions having a phosphoric acid concentration in the range from 30 to 45% by weight have proven particularly effective. They have very particularly advantageous properties since they can be printed well onto the surfaces and give very good etching results.

As mentioned above the acidic component is activated through UV irradiation in the presence of a photo-acid generator. Said photo-acid generators are cationic photoinitiators.

Photo acids or photo acid generator [PAG] are a special class of molecules, which generate acids upon UV irradiation. The most well-known type of photoacid generators are the onium salts, which are described in an exemplary way. These substances were discovered in 1970 in the research laboratories of General Electric Co. and 3M. The onium salts exhibit excellent photoresponse with high efficiencies. This why onium salts are used with high success in the field of the microelectronic photoresists, where these salts are used as photo acid generators for imaging purposes. Among the onium salts the diaryliodonium and triarylsulfonium salts are known best. The general structure of these salts are shown in the following scheme:

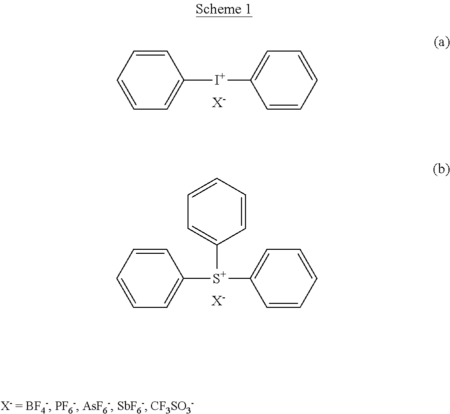

Derivatives of these salts may be used as well.

The mechanism by which a diaryliodonium salt undergoes photolysis when exposed to ultraviolet light is shown in the next scheme, the same mechanism is also valid for the triarylsulfonium salt and slightly modified for their derivatives and other photo acids, even for non-ionic photo acid generator.

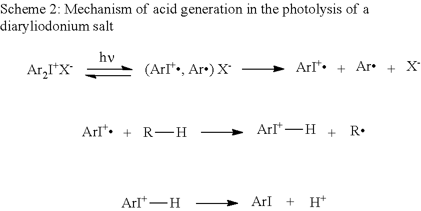

The photolysis rate exhibits a first order dependency on the intensity of irradiation, but it is not significantly influenced by temperature.

Depending on the nature of the photo acid generating substance the acid is liberated by exposure to UV irradiation of different wave lengths. Suitable sources for the UV irradiation are UV lamps, including g-, h-, and i-line (Hg) lamps, deep UV (ArF, KrF) excimer and other UV-laser sources, and UV and near-UV LEDs, and e-beams generating radiation having wave lengths suitable to activate the salts and liberating the reactive acids. In general irradiation with wave lengths lower than 450 nm is suitable for the acid generation, preferably lower than 390 nm, more preferably in the range of 370-1 nm, and most preferred in the range of 370-190 nm. In each case it is necessary to choose the wave length in dependence of the photo acid generating substance.

Today there is a great number of photo acid generators available on the market, which may be ionic or non-ionic. In general the providers inform about the characteristic wave lengths, solubilities and other special properties so that the user can easily choose the most adapted substance for the intended application. In case of the present invention photo acid generators liberating strong acids, especially super acids, are preferred.

A great number of sulfonic acid generating photo acid is disclosed in US 2003/0113658 A1 and suitable photo acids may be selected therefrom. Suitable photo acid generators are onium salts. Preferably suitable photo acid generators are selected from the group Diphenyliodonium triflat, trisulfoniumnonasulfate, nitro benzyl esters, preferably 4-Nitrobenzyl-9-10-dimethoxyanthracene-2-sulfonate, sulfones, especially Phenylacylphenylsulfone, phosphates, especially Triarylphosphates, N-Hydroxyimide sulfonates, and N-Hydroxyphthalimide methane sulfonate, Diazonaphthochlnones, and especially preferred 1-Oxo-2-diazonaphthochinone-5-arylsulfonate. Further photo acid generating substances are may be selected from the following group: Bis(4-tert-butylphenyl)iodonium perfluoro-1-butanesulfonate, Bis(4-tert-butylphenyl)iodonium p-toluenesulfonate, Bis(4-tert-butylphenyl)iodonium triflate, Boc-methoxyphenyldiphenylsulfonium triflate, (4-Bromophenyl)diphenylsulfonium triflate, (tea-Butoxycarbonylmethoxynaphthyl)-diphenylsulfonium triflate, (4-tert-Butylphenyl)diphenylsulfonium triflate, Diphenyliodonium 9,10-dimethoxyanthracene-2-sulfonate, Diphenyliodonium hexafluorophosphate, Diphenyliodonium nitrate, Diphenyliodonium perfluoro-1-butanesulfonate, Diphenyliodonium p-toluenesulfonate, (4-Fluorophenyl)diphenylsulfonium triflate, N-Hydroxynaphthalimide triflate, N-Hydroxy-5-norbornene-2,3-dicarboximide perfluoro-1-butanesulfonate, (4-Iodophenyl)diphenylsulfonium triflate, (4-Methoxyphenyl)diphenylsulfonium triflate, 2-(4-Methoxystyryl)-4,6-bis(trichloromethyl)-1,3,5-triazine, (4-Methylphenyl)diphenylsulfonium triflate, (4-Methylthiophenyl)methyl phenyl sulfonium triflate, (4-Phenoxyphenyl)diphenylsulfonium triflate, (4-Phenylthiophenyl)diphenylsulfonium triflate, Triarylsulfonium hexafluorophosphate salts, Triphenylsulfonium perfluoro-1-butanesufonate, Triphenylsulfonium triflate, Tris(4-tert-butylphenyl)sulfonium perfluoro-1-butanesulfonate, Tris(4-tert-butylphenyl)sulfonium triflate, Bis(cyclohexylsulfonyl)diazomethane, Bis(t-butylsulfonyl)diazomethane, Bis(p-toluenesulfonyl)diazomethane, Triphenylsulfonium trifluoromethanesulfonate, Diphenyl-4-methylphenylsulfonium trifluoromethanesulfonate, Diphenyl-2,4,6-trimethylphenylsulfonium p-toluenesulfonate, Diphenyl[4-(phenylthio)phenyl]sulfonium hexafluorophosphate, Diphenyl[4-(phenylthio)phenyl]sulfonium hexafluoroantimonate, Diphenyl(4-phenylthiophenyl)sulfonium triflate, (4,8-Dihydroxy-1-naphthyl)dimethylsulfonium triflate, (4,7-Dihydroxy-1-naphthyl)dimethylsulfonium triflate, Norbornane-on(3) sulfonic acid ester.

As mentioned before, compositions according to the invention contain photo acid generators in an amount in the range of 0.01 to 5% by weight, preferably less than 1% by weight. In general improved etching activities can be found, if photo acid generators are added in amounts between 0.1 and 0.2%. If photo acid generators are used, which liberate superacids like trifluoromethane sulfonic acid, the activating concentration can be lower than 0.1%.

The solubility in water of a large proportion of the mentioned photo acid generators is limited or they are not water soluble. In this case the etching composition has to comprise either an organic solvent and/or an additional solubilising agent, which may be nonionic and which improves the solubility. Suitable agents for this purpose are solvents, which are usually applied for the preparation of etching pastes. Preferably solvents like acetone, polyhydric alcohols like glycerin, polyethylene glycol, propylene glycol monomethylethylacetate, [2,2-butoxy(ethoxy)]-ethyl acetate, ethers, in particular ethylene glycol monobutyl ether, triethylene glycol monomethyl ether, propylene glycol monomethyl ether, propylene carbonate, cyclopentanone, cyclohexanone, γ-butyrolactone, N-methyl-2-pyrrolidone (NMP), ethyl lactate, methoxypropyl acetate, preferred 1-methoxy-2-propyl acetate, are used, and may be added as such or mixtures of these solvents may be useful. Depending on the nature of the comprising photo acid generator any solvent may added which acts as solubilising agent and which supports a homogeneous distribution but which does not interfere with the compounds of the prepared etching composition having an adverse effect on the etching activity or on other properties of the composition, including its viscosity.

In advantageous variants of the present invention include 25 to 60% by weight of organic solvents in combination with water, preferably 30 to 50% by weight, especially preferred 35 to 45% by weight, while the concentration of water may vary between 10 to 35% by weight, preferably between 15 to 30% by weight, but with the proviso that the amount of comprising solvent and water does not exceed 75% by weight. The sum of all components present in the solution is likewise 100% by weight in each case. It is selfexplaining, that the natures of the chosen organic solvents and all concentrations of organic solvents and of water have to be in a range that the applied photo acid generating compound is chemically inert during storage.

As already mentioned, the compositions of the present invention can be prepared as liquid or pasty composition. These printable, paste-form etching media are suitable for carrying out the process according to the invention as well as liquid etching composition, which can be applied by spraying, spin-coating, dipping or by screen, stencil, stamp, pad or ink-jet printing, depending on the consistency. Thus, if it is desired compositions according to the invention may be thickened to form printable etching pastes and the compositions may comprise in addition to the ingredients characterized above thickeners and optionally additives, such as antifoams, thixotropic agents, flow-control agents, deaerators, sensitizers and adhesion promoters. These additives can positively influence the printability of the etching paste. Based on the total amount, 0 to 5% by weight of additives may be present in the composition employed by the user.

The proportion of thickener necessary in order to set the viscosity range specifically and basically for printability of the etchant, i.e. for the formation of a printable paste, is in the range 0.5-20% by weight, based on the total weight of the etching paste. It is selfexplaining, that the sum of all components present in the solution is likewise 100% by weight in each case.

An essential property of the compositions according to the invention is their viscosity. The viscosity is generally usually defined as the material-dependent proportion of the frictional resistance which counters the movement when adjacent liquid layers are displaced. According to Newton, the shear resistance in a liquid layer between two sliding surfaces arranged parallel and moved relative to one another is proportional to the velocity or shear gradient G. The proportionality factor is a material constant which is known as the dynamic viscosity and has the dimension m Pas. In Newtonian liquids, the proportionality factor is pressure- and temperature-dependent. The degree of dependence here is determined by the material composition. Liquids or substances having an inhomogeneous composition have non-Newtonian properties. The viscosity of these substances is additionally dependent on the shear gradient.

In industrial use, it has been found that the etching compositions according to the invention have particularly good properties if they have, owing to their overall composition, a viscosity at 20° C., which is higher than that of water and which is in the range from 6 to 35 Pa*s at a shear rate of 25 s⁻¹, preferably in the range from 10 to 25 Pa*s at a shear rate of 25 s⁻¹ and especially at 15 to 20 Pa*s at a shear rate of 25 s⁻¹. Depending on the application mode the viscosity of the etching composition may be set by the addition of suitable thickeners.

Non-Newtonian behaviour of the etching pastes is achieved by means of network-forming thickeners which have a swelling action in the liquid phase and can be varied depending on the desired area of application. Thickeners which can be used are organic or inorganic products or mixtures thereof:
cellulose/cellulose derivatives, such as ethyl-, hydroxypropyl- or hydroxyethylcellulose or sodium carboxymethylcellulose
starch/starch derivatives, such as sodium carboxymethylstarch (Vivastar®), anionic heteropolysaccharides
acrylates (Borchigel®)
polymers, such as polyvinyl alcohols (Mowiol®), polyvinylpyrrolidones (PVP)
highly disperse silicic acids, such as Aerosil®

With respect to the use of cellulose/cellulose derivatives, but also the other thickeners, it should be noted that it is only possible to employ derivatives which have sufficient adhesion to the substrate surface, at the same time prevent the spread of the etching medium and facilitate precise printing of extremely thin lines and structures. Thus, for example, it has been found that xanthan derivatives cannot be employed for the purpose according to the invention.

In contrast to organic thickeners, inorganic thickeners, such as, for example, highly disperse silicic acid, have to be added in adequate concentrations which do not adversely influence the irradiation step for liberation of activating acids. Both types of thickener, organic and inorganic, can also be combined as desired with one another in the etching media, enabling different compositions to be selected depending on the application.

It has been found that the addition of suitable finely particulate inorganic and/or organic powders enables particularly thin lines to be printed and etched. Particularly suitable for this purpose are polymer particles which interact with the other components of the composition and form a network by means of chemical bonds or a purely physical interaction at the molecular level. The relative particle diameters of these systems can be in the range from 10 nm to 30 μm. Corresponding polymer particles having a relative particle diameter in the range from 1 to 10 μm have proven particularly advantageous and are preferred. Particles which are particularly suitable for the purpose according to the invention can consist of the following materials:
polystyrene
polyacrylate
polyamide
polyethylene
ethylene-vinyl acetate copolymer
ethylene-acrylic acid-acrylate terpolymer
ethylene-acrylate-maleic anhydride terpolymer
polypropylene
polyimide
polymethacrylate
melamine resin, urethane resin, benzoguanine resin, phenolic resin
silicone resin
fluorinated polymers (PTFE, PVDF, . . . ), and
micronised waxes

The use of a very finely divided polyethylene powder, which is, for example, currently marketed by DuPont PolymerPowders Switzerland under the trade name COATHYLENE HX® 1681, having relative particle diameters d₅₀ value of 10 μm, has proven particularly suitable in the experiments.

These particulate thickeners can be added optionally together with non-particulate thickeners mentioned earlier to the etching medium in amounts of 0.5 to 20% by weight, advantageously the total amount of added thickeners doesn't exceed 20% by weight in the composition, preferably it is in the range of 0.5 to 5% by weight if a thickened composition is needed.

Also suitable in principle are particulate polymeric thickeners based on
polystyrene
polyacrylate
polyamide
polyimide
polymethacrylate
melamine resin, urethane resin, benzoguanine resin, phenolic resin
silicone resin.

Etching media comprising inorganic, finely particulate powders are distinguished by an improved cleaning behaviour. After irradiation and etching the residues of the etching media can be rinsed off in a simple manner without the need for subsequent rinsing since corresponding etching-paste residues advantageously detach from the surface and can be rinsed off simply without re-depositing again elsewhere.

Significant improvements in the present compositions arise, in particular, through considerably improved resolution of etched structures because of the possibility to activate the applied paste selectively by irradiation through a reusable photo mask which is positioned on top of the area, which has to be patterned, enabling continuous printing and etching of surfaces to be treated without interruptions. The use of the etching pastes according to the invention enables considerably finer etching structures since the activated and etched lines depend on the pattern of the reusable photo mask and on the used wave length of the activating irradiation.

For the preparation of the compositions according to the invention, the solvents, etching components, photo acid generators, optionally sensitizers, thickeners, particles and additives are mixed successively with one another and stirred for a sufficient time until a homogeneous composition has formed. The stirring can be carried out with warming to a suitable temperature. The components are usually stirred with one another at room temperature.

The paste is usually printed onto the surface to be etched in a single process step and removed again after a pre-specified exposure time to UV irradiation at suitable temperature. In this way, the surface is etched and structured in the printed areas, while unprinted areas are retained in the original state.

In this way, all masking and lithography steps otherwise necessary are superfluous. The actual etching process is subsequently terminated by washing the surfaces with water and/or a suitable solvent. More precisely, the residues of particle-containing etching media are rinsed off the etched surfaces using a suitable solvent when etching is complete.

The compositions disclosed her can be used for the structuring of oxidic, transparent, conductive layers for the production of solar cells. They are especially suitable for the etching of transparent conductive oxide layers, which consist of indium tin oxide (ITO), fluorine tin oxide (FTO), or aluminium tin oxide (AZO) or antimony tin oxide (ATO). Thus, they are also suitable for oxidic, transparent, conductive layers to be structured in a corresponding manner for the production of flat-panel screens.

The present description enables the person skilled in the art to use the invention comprehensively. If anything is unclear, it goes without saying that the cited publications and patent literature should be used. Correspondingly, these documents are regarded as part of the disclosure content of the present description.

### EXAMPLES

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

The temperatures given in the examples are always in ° C. It furthermore goes without saying that the added amounts of the components in the composition always add up to a total of 100% both in the description and in the examples.

### General Example

Photo-etching pastes are prepared using

### 1. Acid

2. Organic solvent

### 3. Water

4. Suitable Photo-Acid generator.

A suitable composition according to the invention may be composed as follows:

TABLE 2
Composition

| | |
|---|---|
| H₃PO₄ | 40% |
| Acetone | 10% |
| NMP | 30% |
| Water | 15-9.09% |
| Photo acid generator | 0.01-5% |

(This example includes H₃PO₄ as acid and acetone with NMP (N-methylpyrrolidone) as organic solvent. The content of these compounds may be varied.)

### Example 1

TABLE 3
Ingredients of the applied paste

| | |
|---|---|
| H₃PO₄ | 40% |
| Acetone | 10% |
| NM | 30% |
| (N-methylpyrrolidone) | |

| | | |
|---|---|---|
| Water | a) 19.09% | b) 19.8% |
| Photo acid generator | a) 0.1% | b) 0.2% |
| or photo initiator: | | |
| CPI-210S | | |
| (Supplier: San-Apro Ltd.) | | |

The etching composition is prepared by mixing step by step and taking care of the temperature of the mixture. During mixing the temperature should not raise higher than 40° C.

The prepared etching compositions are applied to PET foils (PET=polyethylene terephthalate) furnished with a thin ITO layer (ITO=indium tin oxide) (500-Ω/sq). A movable photo mask is positioned over the coated surface, which shall be patterned by etching and the surfaces are irradiated for different periods of time. The irradiation time tested is in a range of a few seconds and of 2 minutes.

Results of the experiment with different CPI-210S concentrations and UV irradiation times are summarized in Table 4.

TABLE 4

| | | UV irradiation (sec) | | |
|---|---|---|---|---|
| | | 0 | 30 | 60 |
| CPI-210S | 0% | NG | NG | NG |
| | 0.10% | NG | half etched | OK |
| | 0.20% | NG | half etched | OK |

NG: not etched,
OK: well etched

If CPI-210S is applied in a concentration higher than 0.1% by weight, and if the irradiation time is longer than 60 seconds the etching result for ITO layers is perfect.

The chemical structure of CPI-210S is as follows:

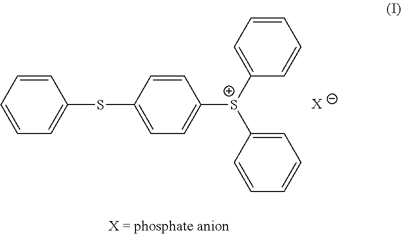

Diphenyl[(phenylthio)phenyl]sulphonium salt

(This salt is the insoluble derivate. Possible salts are the hexafluorophosphate, wherein X⁻ is (PF₆⁻) or the hexafluoroantimonate (SbF₆⁻) or the like.

### Further Examples

In further examples, the following photo-acid generators are used:
1. WPAG-281 (Triphenylsulfonium trifluoromethanesulfonate or Triphenylsulfonium triflate)
   Supplier: Wako Pure Chemical Industries Ltd.

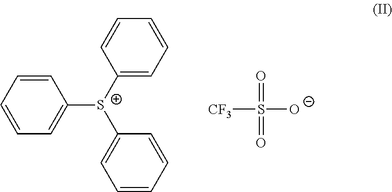 [SMILES: c1ccc([S+](c2ccccc2)c2ccccc2)cc1 ; O=S(=O)([O-])C(F)(F)F]

2. WPAG-336 (Diphenyl-4-methylphenylsulfonium trifluoromethanesulfonate) Supplier: Wako Pure Chemical Industries Ltd.

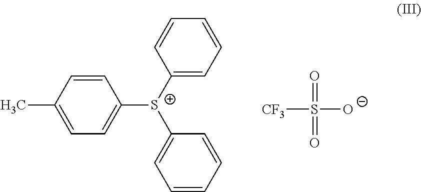 [SMILES: Cc1ccc([S+](c2ccccc2)c2ccccc2)cc1 ; O=S(=O)([O-])C(F)(F)F]

3. WPAG-367 (Diphenyl-2,4,6-trimethylphenylsulfonium p-toluenesulfonate) Supplier: Midori Kagaku Co., Ltd.

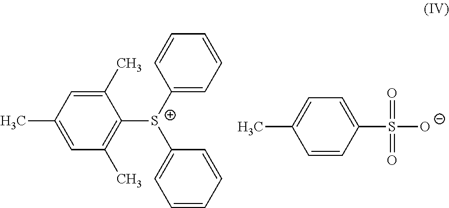 [SMILES: Cc1cc(C)c([S+](c2ccccc2)c2ccccc2)c(C)c1 ; Cc1ccc(S(=O)(=O)[O-])cc1]

4. DTS-102 (Diphenyl[4-(phenylthio)phenyl]sulfonium hexafluorophosphate)

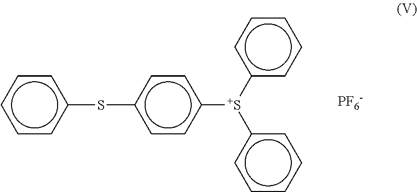

5. DTS-103 (Diphenyl[4-(phenylthio)phenyl]sulfonium hexafluoroantimonate)

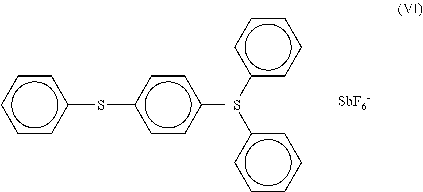

6. DTS-105 (Diphenyl(4-phenylthiophenyl)sulfonium triflate

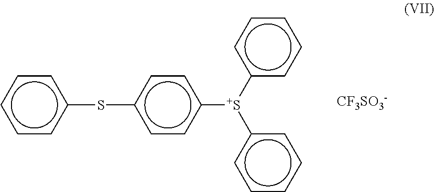

7. DTS-155 ((4,8-Dihydroxy-1-naphthyl)dimethylsulfonium triflate)

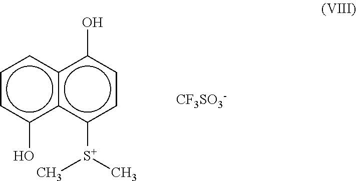

8. DTS-165 ((4,7-Dihydroxy-1-naphthyl)dimethylsulfonium triflate)

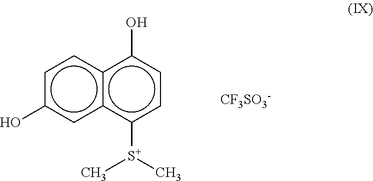

Supplier: Eiweiss Chemicals Corporation
9. CTPAG (Norbornane-on(3) sulfonic acid ester)

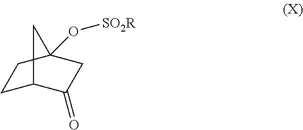

Six different basic mixtures are prepared, to which different photo acids in a concentration of 0.1 and 0.2% by weight are added. The compositions are as follows:

TABLE 5

| | Mixture 1 | 2 | 3 | 4 | 5 | 6 |
|---|---|---|---|---|---|---|
| H3PO4 | 40.0 | 30.0 | 0.0 | 14.3 | 25.0 | 33.3 |
| acetone | 10.0 | | 16.7 | 14.3 | 12.5 | 11.1 |
| NMP | 30.0 | | 50.0 | 42.9 | 37.5 | 22.2 |
| water | 20.0 | 20.0 | 33.3 | 28.6 | 25.0 | 33.3 |
| propylene | | 20.0 | | | | |
| carbonate | | | | | | |
| glycerine | | 30.0 | | | | |
| photo acid | | | | | | |
| 0.1 or | | | | | | |
| 0.2% | | | | | | |

DTS-165 as photo acid generator shows very poor solubility in compositions tested here and doesn't lead to satisfying etching effects.

The evaluation of etching results shows, that in general at least 25% by weight of H₃PO₄ are needed in order to achieve a good etching results. This is in agreement with the finding that mixtures 3 and 4 do not show distinct photo-etching effects.

Etching compositions comprising CPI-210, DTS-105, WPAG-281, WPAG-367 as photo acid generators lead to good etching results depending on the concentration of phosphoric acid and on the exposure time to UV light.

Satisfying etching results can be obtained, if the used photo-acid generators are added in concentrations in the range of 0.1-5 wt %. Preferably the photo acids should be added in a concentration of at least 0.2% by weight, but the addition of more than 5% by weight doesn't lead to any further achievement of the etching results.

In order to activate the etching reaction a UV lamp was used (“USHIO” VB-15201 BY-A 1 KW Hg lamp).

When the etching composition was applied to the surface to be etched, an exposure time to UV irradiation of 30 sec-90 sec leads to good etching results depending on the concentration of comprising phosphoric acid.

1. Method for the etching of transparent conductive oxide layers placed on flexible polymer substrates or on hard substrate like glass or a silicon wafer, comprising the steps of
a) applying etching pastes comprising at least one compound, which is
a photo-acid generator,
b) activating the etching composition by UV irradiating those areas,
which shall be etched,
c) removing the etching paste by rinsing off with water
and
d) drying the treated surface.

2. Method according to claim 1 for the etching of transparent conductive oxide layers, which consist of indium tin oxide (ITO), fluorine tin oxide (FTO), or aluminium tin oxide (AZO) or antimony tin oxide (ATO).

3. Method according to claim 1, characterized in that a thin layer of etching paste is applied on to the transparent conductive oxide layer the by spin coating.

4. Method according to claim 1, characterized in that etching paste is applied in a pattern on to the transparent conductive oxide layer by screen printing, silk-screen printing, pad printing, stamp printing and ink-jet printing.

5. Method according to claim 4, characterized in that the applied etching composition is activated by irradiating the entire surface layer, by what only the surface areas covered by etching composition are etched.

6. Method according to claim 1, characterized in that at first a photo mask is positioned over the transparent conductive oxide layer, which is covered with etching paste and that only those areas are activated by irradiation, which are irradiated through the pattern of the photo mask.

7. Method according to claim 1, characterized in that the UV irradiation lasts for 20 seconds to 2 minutes.

8. Etching composition, comprising
a) at least one compound, which is a photo acid generator
b) an etching component selected from the group phosphoric acid (ortho-, meta- or pyro-), and its salts (NH₄)₂HPO₄ and NH₄H₂PO₄, meta-phosphorus pentoxide, phosphonic acid, n-butyl phosphoric acid, di-n-butyl phosphoric acid, oligo- and polyphosphoric acids, phosphonic acid, phosphinic acid, phenylphosphinic acid, phenylphosphonic acid,
or selected from the group mono-, di- or triesters of the said phosphoric acids, especially monomethyl phosphate, di-n-butyl phosphate (DBP) and tri-n-butyl phosphate (TBP),
c) at least an organic solvent selected from the group acetone, polyhydric alcohols like glycerin, polyethylene glycol, propylene glycol monomethylethylacetate, [2,2-butoxy(ethoxy)]-ethyl acetate, ethers, in particular ethylene glycol monobutyl ether, triethylene glycol monomethyl ether, propylene glycol monomethyl ether, propylene carbonate, cyclopentanone, cyclohexanone, γ-butyrolactone, N-methyl-2-pyrrolidone (NMP), ethyl lactate, and methoxypropyl acetate, preferably 1-methoxy-2-propyl acetate,
d) water,
e) optionally at least one thickener,
and
f) optionally additives.

9. Etching composition according to claim 8, comprising an etching component in a concentration in the range from about 25 to 50% by weight.

10. Etching composition according to claim 8, comprising phosphoric acid as etching component.

11. Etching composition according to claim 8, comprising a photo-acid generator selected from the group Diphenyliodonium triflat, trisulfoniumnonasulfate, nitro benzyl esters, preferably 4-Nitrobenzyl-9-10-dimethoxyanthracene-2-sulfonate, sulfones, especially Phenylacylphenylsulfone, phosphates, especially Triarylphosphates, N-Hydroxyimide sulfonates, and N-Hydroxyphthalimide methane sulfonate, Diazonaphthochinones, and especially preferred 1-Oxo-2-diazonaphthochinone-5-arylsulfonate. Further photo acid generating substances are may be selected from the following group:
Bis(4-tert-butylphenyl)iodonium perfluoro-1-butanesulfonate, Bis(4-tert-butylphenyl)iodonium p-toluenesulfonate, Bis(4-tert-butylphenyl)iodonium triflate, Boc-methoxyphenyldiphenylsulfonium triflate, (4-Bromophenyl)diphenylsulfonium triflate, (tert-Butoxycarbonylmethoxynaphthyl)-diphenylsulfonium triflate, (4-tert-Butylphenyl)diphenylsulfonium triflate, Diphenyliodonium 9,10-dimethoxyanthracene-2-sulfonate, Diphenyliodonium hexafluorophosphate, Diphenyliodonium nitrate, Diphenyliodonium perfluoro-1-butanesulfonate, Diphenyliodonium p-toluenesulfonate, (4-Fluorophenyl)diphenylsulfonium triflate, N-Hydroxynaphthalimide triflate, N-Hydroxy-5-norbornene-2,3-dicarboximide perfluoro-1-butanesulfonate, (4-Iodophenyl)diphenylsulfonium triflate, (4-Methoxyphenyl)diphenylsulfonium triflate, 2-(4-Methoxystyryl)-4,6-bis(trichloromethyl)-1,3,5-triazine, (4-Methylphenyl)diphenylsulfonium triflate, (4-Methylthiophenyl)methyl phenyl sulfonium triflate, (4-Phenoxyphenyl)diphenylsulfonium triflate, (4-Phenylthiophenyl)diphenylsulfonium triflate, Triarylsulfonium hexafluorophosphate salts, Triphenylsulfonium perfluoro-1-butanesufonate, Triphenylsulfonium triflate, Tris(4-tert-butylphenyl)sulfonium perfluoro-1-butanesulfonate, Tris(4-tert-butylphenyl)sulfonium triflate, Bis(cyclohexylsulfonyl)diazomethane, Bis(t-butylsulfonyl)diazomethane, Bis(p-toluenesulfonyl)diazomethane, Triphenylsulfonium trifluoromethanesulfonate, Diphenyl-4-methylphenylsulfonium trifluoromethanesulfonate, Diphenyl-2,4,6-trimethylphenylsulfonium p-toluenesulfonate, Diphenyl[4-(phenylthio)phenyl]sulfonium hexafluorophosphate, Diphenyl[4-(phenylthio)phenyl]sulfonium hexafluoroantimonate, Diphenyl(4-phenylthiophenyl)sulfonium triflate, (4,8-Dihydroxy-1-naphthyl)dimethylsulfonium triflate, (4,7-Dihydroxy-1-naphthyl)dimethylsulfonium triflate, Norbornane-on(3) sulfonic acid ester.

12. Etching composition according to claim 8, comprising a photo-acid generator selected from the group Triphenylsulfonium trifluoromethanesulfonate, Diphenyl-4-methylphenylsulfonium trifluoromethanesulfonate, Diphenyl-2,4,6-trimethylphenylsulfonium p-toluenesulfonate, Diphenyl[4-(phenylthio)phenyl]sulfonium hexafluorophosphate, Diphenyl[4-(phenylthio)phenyl]sulfonium hexafluoroantimonate, Diphenyl(4-phenylthiophenyl)sulfonium triflate, (4,8-Dihydroxy-1-naphthyl)dimethylsulfonium triflate, Norbornane-on(3) sulfonic acid ester.

13. Etching composition according to claim 8, comprising a photo-acid generator in a concentration in the range from about 0.01 to 5% by weight.

14. Etching composition according to claim 8, comprising organic solvent in a concentration in the range of 25 to 60% by weight and water in a concentration in the range of 10 to 35% by weight with the proviso that the amount of comprising solvent and water doesn't exceed 75% by weight.
